(19) United States
(12) Patent Application Publication
(10) Pub. No.: US 2007/0174807 A1
(43) Pub. Date: Jul. 26, 2007

(54) Semiconductor device manufacturing method, library used for the same, recording medium, and semiconductor device manufacturing system

(76) Inventors: Masahiko Kumashiro, Osaka (JP); Tadashi Tanimoto, Shiga (JP)

Correspondence Address: MCDERMOTT WILL & EMERY LLP, 600 13TH STREET, N.W., WASHINGTON, DC, 20005-3096, US

(21) Appl. No.: 11/487,970

(22) Filed: Jul. 18, 2006

(30) Foreign Application Priority Data
Sep. 12, 2005 (JP) P2005-264108

(51) Int. Cl. G06F 17/50

(52) U.S. Cl. 716/21

(57) ABSTRACT

To provide a semiconductor device manufacturing method of making a pattern formation possible with high precision at a high speed, the same block can be completed by one process a cell by dividing the layout data into cells in the OPC processing step and then applying the OPC to each cell, and the OPC is applied only to the cell boundary portions after respective OPC-applied cells are arranged on the chip, so that a dimensional precision in vicinity of the cell boundaries can be ensured. Also, since the patterns on the cell boundary portions are caused to shrink uniformly, the OPC of the cell boundary portions can be simplified and thus the fast process can be applied.

### BACKGROUND OF THE INVENTION

1. Field of the Invention

The present invention relates to a semiconductor device manufacturing method, a library used for the same, a recording medium, and a semiconductor device manufacturing system and, more particularly, the correction of a design pattern to reduce influences of the optical proximity effect in a semiconductor device designing method and also a verification of the pattern.

2. Description of the Related Art

In the research and development or development and trial manufacture stage of semiconductor steps, as the technology to grasp characteristic of the processes or the products and test virtually prediction and evaluation of the characteristic depending on manufacturing conditions, the computer simulation technology is utilized currently as the indispensable technology to semiconductor design.

In particular, the simulation technology of the photolithography process serving as the fine pattern machining technology, which is the core of the semiconductor manufacturing technologies, is established theoretically and is used as the technology indispensable to the research and development.

The simulation of the exposing process among the photolithography simulations is referred particularly to as the “light intensity simulation”. According to this simulation, when a photomask pattern (referred to as the mask pattern hereinafter) is exposed/transferred onto a wafer by using the projection exposure system (also referred to as the stepper hereinafter), a light intensity distribution of the projected light image is derived by the computation.

A theory applied as the basis of the light intensity simulation technology has already established, and also various computer computational models have been proposed. Also, a soft ware used for the computer simulation is called a simulator.

According to such simulation, an exposure distribution on the wafer can be estimated without an actual application of the lithography. Therefore, the light intensity simulation is utilized frequently in the research and development or the trial manufacture of the device using the lithography step.

In particular, recently the requested fine pattern machining technology reaches a limit of the machining using a light and also the device development based on the actual experiment is difficult technically and in cost. Thus, a simulation approach capable of deriving the simulation result quickly and in low cost by utilizing the computer is becomes important more and more.

Also, in the pattern designing steps, the design simulation is employed in the prior art to attain the desired electronic characteristics/circuit characteristics in the logic design, the circuit design, and the like. Also, the simulation is indispensable to the mass production steps at present.

Meanwhile, now the optical proximity correction (OPC) technology is observed with interest in the lithography. The OPC is the technology that keeps a finished value of an exposed wiring width at a constant value by predicting a variation in the wiring width caused due to the optical proximity effect of the wiring pattern based on a distance from the wiring pattern to the neighboring wiring pattern, and then correcting in advance a resist pattern forming mask, which is used to form the wiring pattern, to cancel such variation. However, this technology needs the processing of the mask pattern.

In addition, this machining rule is different from a design rule of the logic circuit, and thus exposure conditions, developing conditions, etc. in the lithography step must be set as process conditions. As a result, an optimizing means in which at least the exposure step is taken into account is needed to optimize the mask pattern. Therefore, a means for optimizing the pattern based on the exposure conditions by utilizing the light intensity simulation is needed.

However, actual pattern data of LSIs are extremely complicated and massive, and normally consist of several hundreds of thousands to several million closed figures. It is absolutely certain that such pattern data are further increased in future. Thus, it is extremely difficult in time and cost that, in order to optimize the fine pattern machining precision of the patterns that need such enormous amount of data, the light intensity simulation should be applied to the overall mask pattern and also the OPC process should be applied to them.

In the prior art, the optical proximity correcting method and the correction pattern verifying method of the semiconductor device are applied to the overall surface of the chip to thus consider the influence of the optical proximity effect in the cell boundary area (JP-A-2002-107908).

However, the optical proximity correction of design patterns becomes more sensitive with the process miniaturization, and thus the complicated high-precision correction depending upon shapes of the neighboring cells is needed. Accordingly, when the transistors are integrated on the overall surface of the LSI chip on a several tens of millions scale, a vast CAD time is needed in the OPC process and a shortening of a design term is demanded by accelerating the OPC process.

Therefore, the method of registering basic cells, on the outer periphery of which dummy wiring patterns are formed respectively, in a basic cell library has been proposed (JP-A-10-32253). In other words, according to this method, the dummy patterns are provided to the outer peripheries every basic cell such that a distance between a polysilicon gate used in the circuit of the basic cell and a dummy wiring pattern located in vicinity of this gate can be defined in the cell, then the magnitude of variation in the gate width caused due to the optical proximity correction is predicted, and then a gate width on the mask is corrected.

However, in the above method, basic cell units must be fixed and also an increase in a cell area of the dummy wiring patterns cannot be avoided, though a computational complexity required for the correction can be reduced. Therefore, this situation becomes a big problem that arrests the miniaturization and the higher integration of the cells.

In this manner, the optical proximity correction (abbreviated as OPC hereinafter) of the design pattern becomes more sensitive as the process is miniaturized. Thus, the demands for the complicated high-precision correction depending upon the shapes of neighboring cells and a reduction of the design term by accelerating the OPC process are increased.

### SUMMARY OF THE INVENTION

The present invention has been made in view of the above circumstances, and aims at providing a semiconductor device manufacturing method of making a pattern formation possible with high precision at a high speed. More particularly, it is an object of the present invention to provide an OPC system and an after-OPC pattern verifying system, capable of executing OPC of a design pattern and lithography simulation and verification with high precision and at a high speed and also contributing to improvements of a yield in semiconductor manufacture.

In the present invention, the same block can be completed by one process a cell by dividing the layout data into cells in the OPC processing step and then applying the OPC to each cell, and the OPC is applied only to the cell boundary portions after respective OPC-applied cells are arranged on the chip, so that a dimensional precision in vicinity of the cell boundaries can be ensured. Also, since the patterns on the cell boundary portions are caused to shrink uniformly, the OPC of the cell boundary portions can be simplified and thus the fast process can be applied. In addition, since the OPC-applied cells to be arranged in the boundary portions in which particular cells are located adjacently are prepared previously as the library, the OPC process after the cell arrangement can be omitted and thus the fast process can be applied. Further, since dummy gates are formed in vicinity of the boundary portions of the cells and then the correcting process such as the shrink process, or the like is applied to the dummy gates after the OPC process of the cells, occupied areas can be reduced with higher precision.

Since the lithography verifying step is divided into the step of applying on a cell basis and the step of verifying only the cell boundary portions, the redundant verification applied to the same cells can be omitted and thus a fast verification can be achieved.

More particularly, the semiconductor device manufacturing method of the present invention includes a step of dividing layout data of an integrated circuit constituting a semiconductor device into a plurality of blocks; an OPC processing step of applying an optical proximity correction (referred to as OPC hereinafter) every block; a boundary portion correcting step of correcting patterns of boundary portions between the blocks; and a step of forming desired patterns by executing an exposure based on the layout data after the boundary portion correcting step.

According to this method, since the same block can be completed by one process a cell by dividing the layout data into cells in the OPC processing step and then applying the OPC to each cell, a processing time can be greatly reduced. Also, if the OPC is applied only to the block boundary portions after respective OPC-applied blocks are arranged on the chip, a dimensional precision such as a gate dimension in vicinity of the block boundary, or the like can be ensured.

Also, the semiconductor device manufacturing method of the present invention further includes a step of dividing the layout data into a plurality of cells; an OPC processing step of applying an optical proximity correction (abbreviated as OPC hereinafter) every cell; and a boundary portion correcting step of correcting patterns of the boundary portions between the cells.

According to this method, since the same cell can be completed by one process by dividing the layout data into cells in the OPC processing step and then applying the OPC to each cell, a processing time can be greatly reduced. Also, if the OPC is applied only to the block boundary portions after respective OPC-applied blocks are arranged on the chip, a dimensional precision such as a gate dimension in vicinity of the cell boundary, or the like can be ensured.

Also, the semiconductor device manufacturing method the present invention further includes a step of arranging/synthesizing respective OPC-applied cells, to which the OPC process is applied, to generate corrected layout data.

According to this method, the cells are synthesized after the layout data is divided into the cells once to apply the OPC. Therefore, a processing time can be shortened.

Also, in the semiconductor device manufacturing method of the present invention, the boundary portion correcting step is a step of correction patterns of the cell boundary portions to shrink.

The OPC process is applied under the assumption that no pattern is present at the boundary portion, and as a result the patterns of the boundary portions are increased in size. Therefore, a pattern precision can be improved extremely easily by executing a shrink correction simply.

Also, in the semiconductor device manufacturing method of the present invention, the boundary portion correcting step is a step of correcting patterns of divided blocks or the cell boundary portions in compliance with a correction rule decided previously based on a design rule.

According to this method, a higher-precision correction can be achieved.

Also, in the semiconductor device manufacturing method of the present invention, the boundary portion correcting step is a step of correcting patterns of divided blocks or the cell boundary portions in compliance with a correction rule decided previously in response to a model.

According to this method, the correction data can be prepared easily in advance as the library, and a high-precision correction can be achieved easily.

Also, in the semiconductor device manufacturing method of the present invention, the boundary portion correcting step adjusts partially the correction rule in response to a required pattern precision.

According to this method, a higher-precision correction can be achieved.

Also, in the semiconductor device manufacturing method of the present invention, the boundary portion correcting step sets the correction rule uniformly over a whole chip.

According to this method, the correction can be achieved at a higher speed.

Also, in the semiconductor device manufacturing method of the present invention, the OPC processing step applies the OPC process only to cells that are used in the integrated circuit in excess of a predetermined number.

According to this method, a higher-speed correction can be achieved.

Also, the semiconductor device manufacturing method of the present invention further includes a storing step of storing OPC-applied cells obtained by applying the correction to the boundary portions of particular cells obtained in the OPC processing step as a library when particular cells are located adjacently; and a step of taking out the OPC-applied cells from the library and applying.

According to this method, it is needed to look up the library only and there is no necessity to execute the correction sequentially. Therefore, the high-precision and high- reliability correction can be achieved in a short time.

Also, the semiconductor device manufacturing method of the present invention further includes a step of applying a lithography simulation verification (referred to as a “lithography verification” hereinafter) on a divided-unit basis.

According to this method, the verification can be executed easily.

Also, the semiconductor device manufacturing method of the present invention further includes a step of applying the lithography verification only to the cell boundary portions in the integrated circuit.

According to this method, the defect readily occurs in the cell boundary portion when the correction is applied on a cell basis. Therefore, the defect can be easily sensed by applying the verification to the cell boundary portion.

Also, the semiconductor device manufacturing method of the present invention further includes a step of applying a lithography simulation verification (referred to as a “lithography verification” hereinafter) on a divided-unit basis.

According to this method, the high-precision verification can be executed in a shorter time.

A recording medium of the present invention is constructed such that procedures in respective steps in the semiconductor device manufacturing method are recorded in a computer-readable manner.

Also, a library of the present invention stores data to which an OPC process is applied in the semiconductor device manufacturing method. Since the data obtained by applying the OPC process to the layout data of respective cells are stored in the library and also the boundary area OPC process data corresponding the number of neighboring cell combinations are stored, the layout design can be completed in a very short TAT. Also, the layout data that permit the formation of the high- precision patterns effectively in a short time can be obtained by preparing correction data responding to the lithography conditions.

Also, a semiconductor device manufacturing system of the present invention includes a data input portion for inputting layout data of an integrated circuit constituting a semiconductor device; a divide portion for dividing the layout data input by the data input portion into a plurality of blocks; an OPC process portion for applying an optical proximity correction (referred to as OPC hereinafter) every block; a synthesize portion for arranging/synthesizing respective OPC-applied blocks to which the OPC process is applied; and an exposure portion for executing an exposure based on corrected layout data to form desired patterns on a mask blank; wherein the OPC process portion has a library that stores OPC-processed data of respective blocks and boundary portion correction data used to correct patterns of boundary portions between the blocks, and the synthesize portion reads the data from the library and synthesizes the data to generate the layout data.

According to the present invention, since the OPC process is applied every block and the OPC process is applied to the boundary areas, in which a variation in the pattern is easily brought about, by applying the shrink correction to the boundary areas, and the like, the pattern formation can be carried out at a high speed with high precision. Also, the OPC process and the lithography simulation and verification of the design patterns can be carried out at a high speed with high precision, and also a reduction in cost and improvements of yield in the semiconductor manufacture can be achieved.

### BRIEF DESCRIPTION OF THE DRAWINGS

FIG. 1 is a view explaining the concept of a semiconductor device manufacturing method of an embodiment 1 of the present invention.

FIG. 2 is a diagram showing a semiconductor device manufacturing system of the embodiment 1 of the present invention.

FIG. 3 is a chart showing a process flow in the semiconductor device manufacturing method of the embodiment 1 of the present invention.

FIG. 4 is an explanatory view showing the semiconductor device manufacturing method of the embodiment 1 of the present invention.

FIG. 5 is a chart showing a process flow in a semiconductor device manufacturing method of an embodiment 2 of the present invention.

FIG. 6 is a diagram showing a semiconductor device manufacturing system of an embodiment 3 of the present invention.

FIG. 7 is a chart showing a process flow in a semiconductor device manufacturing method of the embodiment 3 of the present invention.

### DESCRIPTION OF THE PREFERRED EMBODIMENTS

Embodiments of the present invention will be explained in detail with reference to the drawings hereinafter.

### Embodiment 1

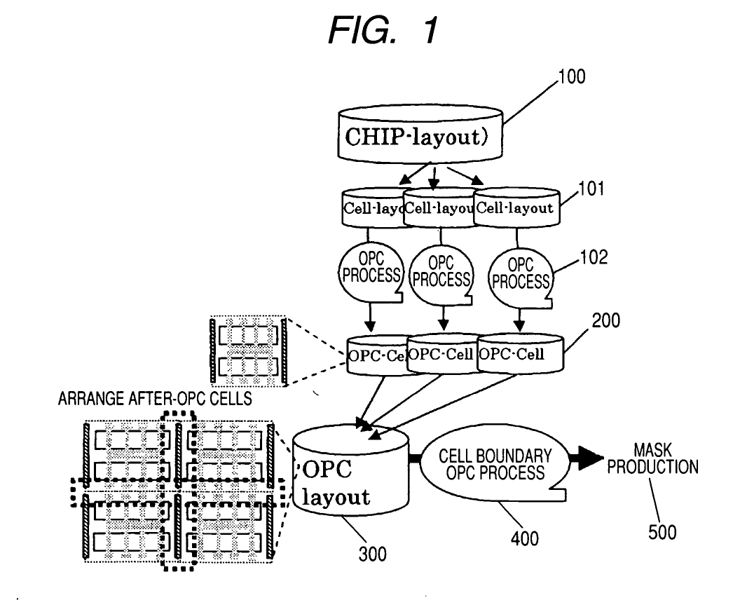

FIG. 1 is a conceptual view showing a semiconductor device manufacturing method of an embodiment 1 of the present invention.

As shown in FIG. 1, this method includes the step of dividing layout data of an integrated circuit constituting the semiconductor device into a plurality of cells, the OPC step of applying the optical proximity correction (abbreviated as OPC hereinafter) every cell, the step of forming desired patterns by executing the exposure based on the layout data after the correction is applied, the step of arranging/synthesizing respective OPC-applied cells to which the OPC processing step is applied, and the step of correcting cell boundary portions by the boundary area OPC process.

In other words, as shown in a conceptual view of FIG. 1, cell layout data 101 are generated by dividing layout data 100 every cell, and then the cell OPC process (step 102) is executed every cell layout data. Thus, OPC cells 200 are obtained. Then, an OPC layout 300 is obtained by synthesizing the OPC cells 200. Then, a cell boundary area OPC process (step 400) is applied to cell boundary portions in the OPC layout 300. After this process, a mask production (step 500) is executed based on the after-OPC layout data.

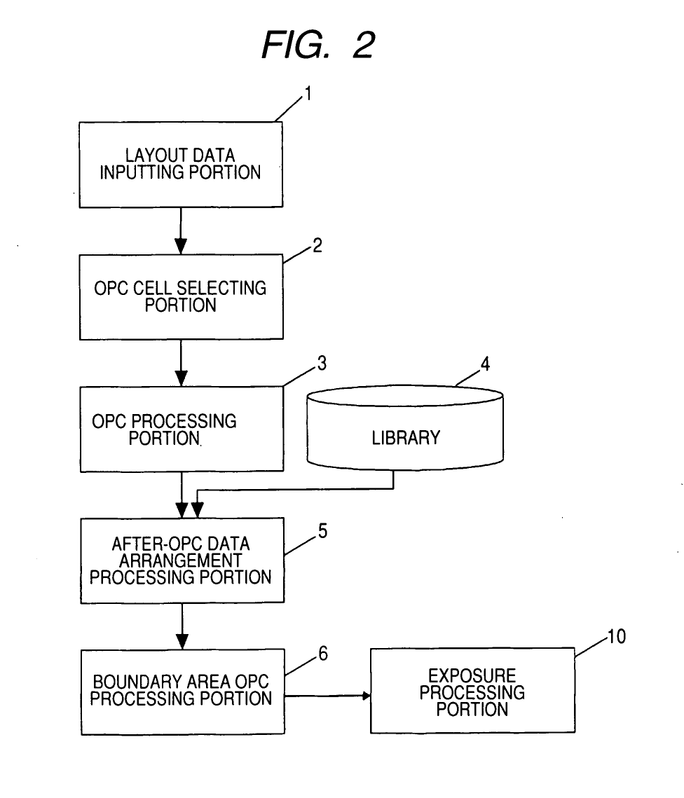

As shown in FIG. 2 as an example, first a semiconductor device manufacturing system that carries out this data flow includes a layout data inputting portion 1 for inputting the layout data, an OPC cell selecting portion 2 for dividing the input layout data into blocks or cells and selecting the cells to which the OPC process is applied, an OPC processing portion 3 for executing the cell OPC process explained in FIG. 1, an after-OPC data arrangement processing portion 5 for executing arrangement synthesis based on the corrected layout data obtained by the OPC processing portion 3 and also applying an after-OPC data arrangement process by extracting necessary data from a library 4, a boundary area OPC processing portion 6 for executing the OPC process on the cell boundary portions, and an exposure processing portion 10 for executing an exposing process based on data calculated by the boundary area OPC processing portion 6 and used for the EB exposure, i.e., EB data.

Here, the OPC processing portion 3 executes the division into cells, the cell OPC process (step 102) every cell layout data, and the synthesis of the derived OPC cells 200, as shown in FIG. 1. Then, the arrangement processing portion 5 executes the arrangement of the OPC layout 300 obtained by synthesizing the OPC cells 200. Then, the boundary area OPC processing portion 6 executes the cell boundary area OPC process (step 400) and forms layout data on the mask.

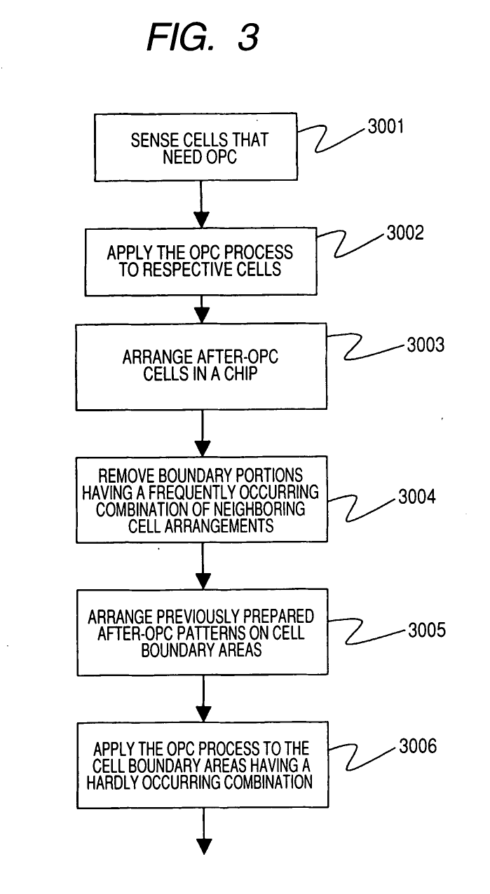

Next, this method will be explained in compliance with a process flow shown in FIG. 3 hereunder.

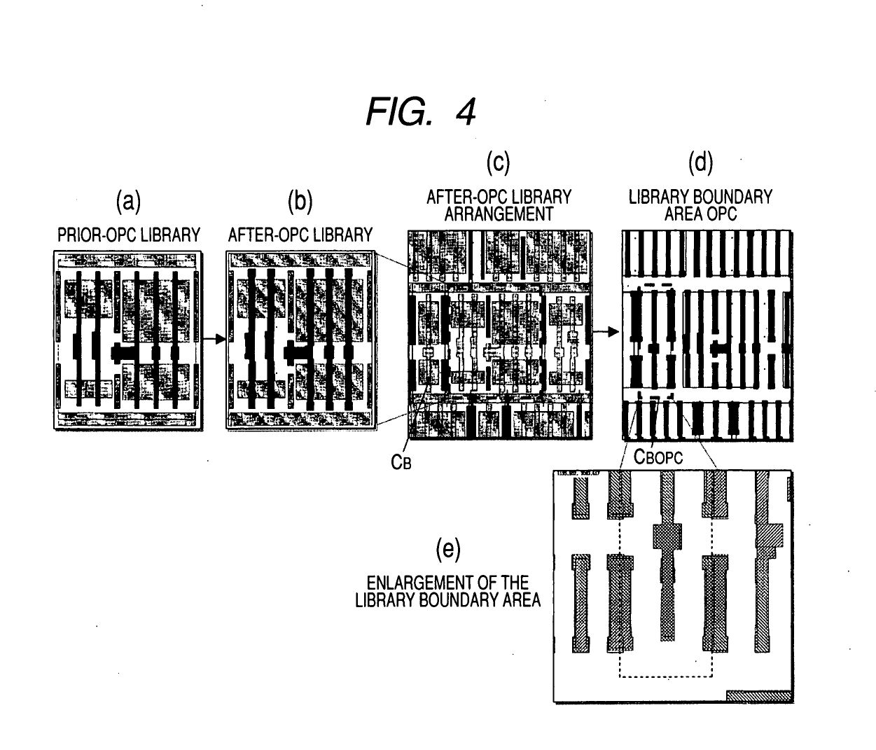

First, the cells that need the OPC are selected from the layout data being input by the layout data inputting portion 1 at an appropriate layer level (step 3001), and then the OPC process is applied individually to the selected cells (step 3002). Because the cells are selected at the layer level and then the OPC process is applied to them in this manner, a CAD process time can be reduced by omitting a time and a labor that are consumed to apply the OPC process to the same cells repeatedly and also TAT can be shortened. FIG. 4(a) is a view showing the layout data in unit cell in the prior-OPC library. The layout data obtained after the OPC process is applied to the above layout data is shown in FIG. 4(b).

Then, the after-OPC cells obtained by applying the OPC process in step 3002 based on the cell layout arrangement information prior to the application of the OPC process are arranged on the chip (step 3003). FIG. 4(c) is a view showing the library arrangement after the OPC process is applied. There is a pattern C_{B} of the OPC-processed cell layout Co_{OPC} boundary portion.

Then, the total layout information are verified, and then patterns of the cell boundary portions containing a number of neighboring cell combinations out of the after-OPC cells that are arranged in step 3003 are removed from the after-OPC data (step 3004).

In step 3005, cell boundary patterns C_{BOPC} that are previously prepared as the library are arranged in areas from which the patterns are removed (FIG. 4(d)). As a result, the OPC areas of the cell boundary portions after the cell arrangement can be reduced and also a CAD time can be shortened. FIG. 4(e) is an enlarged view.

The cell boundary pattern library gives such a pattern that the OPC is applied to the cell layout that are arranged adjacently before the OPC is applied and then only the cell boundary portion is cut off. Because the above cell boundary portions are replaced in this manner after the cells are arranged, a correction precision can be realized to the same extent as the OPC applied to the chip arrangement.

Finally, in step 3006, the OPC is applied to remaining cell boundary areas that have not replaced in step 3005.

In this manner, the cell boundary patterns C_{BOPC} that are subjected to the OPC process and previously stored in the library are used in the cell boundary areas containing a number of neighboring cell combinations. Therefore, a correcting precision that is almost equivalent to that of the chip-scale OPC can be attained at high speed in a cell-scale OPC time.

The EB exposing process is applied to mask blanks, on which the resist is coated, based on the layout data obtained in this manner, and then resist patterns are formed by developing the resist. Then, chromium patterns are formed by etching a chromium thin film on the mask blank while using the resist patterns as a mask. The mask in which the chromium patterns are formed is used as the photomask. In case this photomask is the photomask used to form wiring patterns, for example, the resist is coated on the silicon wafer on which a metal thin film is formed, and then the exposing process is applied to this silicon wafer via the photomask.

Then, the resist patterns are formed by developing latent images formed by the exposing process. Then, desired gate patterns are formed by etching a polysilicon thin film while using the resist patterns as a mask.

According to this method, the redundant process of the same cell can be omitted by applying the OPC on a cell basis in the OPC process step, and thus a processing time required for the chip layout can be greatly reduced.

Also, since only peripheries of the cells that are optically influenced can be corrected once again under such a condition that internal corrected results of the cells are fixed after the OPC-processed cells are arranged in layout, a dimensional precision of the transistor can be improved.

In this case, in the above embodiment, the OPC is applied individually to the cell boundary portions in step 3006. A simple process of dealing with only the short circuit may be applied dependent on the location, and thus the higher-speed process cab be carried out.

Also, in the above embodiment, the formation of the mask patterns used to form the photomask, which is used to form the gate patterns, is explained. But the present invention is not limited to this application.

In addition, there is no need that the correction should be completed at this correction. The correction can be applied in such a manner that various adjustments should be executed in the course of process by adjusting the process conditions in the etching process.

### Embodiment 2

Next, an embodiment 2 of the present invention will be explained hereunder.

In the above embodiment 1, the frequently occurring boundary portions in the combination of the neighboring cell arrangements are selected, then the patterns of the frequently occurring boundary portions are removed, and then patterns of these boundary portions are picked up from the library and then arranged in corresponding areas, so that improvement of the correcting precision can be achieved. In the present embodiment, a simplified correction can be accomplished by causing only the patterns of the neighboring cell boundary areas to shrink after the arrangement.

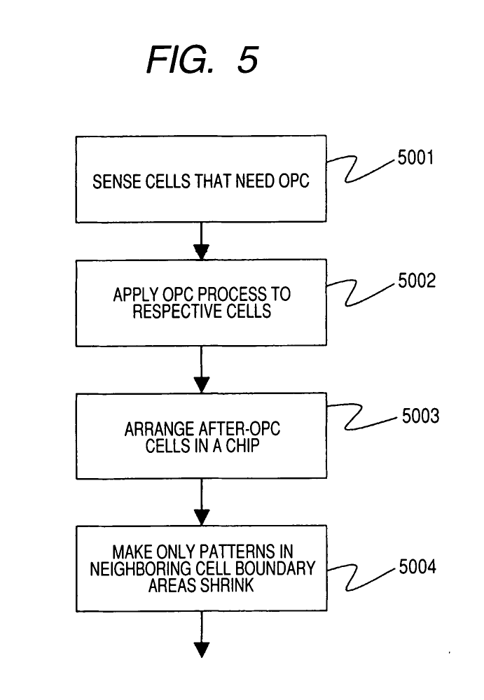

FIG. 5 shows a process flow to explain this method.

First, like the embodiment 1, the cells that need the OPC are selected at an appropriate layer level from the layout data being input from the layout data inputting portion (step 5001). Then, the OPC process is applied individually to the selected cells (step 5002).

Then, the after-OPC cells processed in step 5002 are arranged based on the cell layout arrangement information before the OPC is applied (step 5003).

Then, only patterns in neighboring cell boundary areas are caused to shrink in a predetermined width in compliance with the previously decided rule (step 5004).

According to this method, the OPC can be applied simply with almost equivalent precision.

In the case where the OPC is applied individually to the cells, there is such a tendency that, since no pattern is present around the cell, an after-OPC dimension becomes thick in the cell boundary areas rather than the case where the neighboring cells are present.

Therefore, in step 5004, a dimensional shrinkage is applied simply to the patterns whose cell boundary portions are thickened after the cells that underwent the OPC process in step 5003 are arranged in a chip. As a result, the high-speed process can be attained by simplifying the process while keeping the precision.

In this manner, the after-OPC pattern in the cell boundary area becomes thicker than the optimal solution when the correction is applied on a single-cell basis. Therefore, the corrected shape that is close to the optimal solution can be calculated in a short TAT by causing the after-OPC pattern to shrink simply after the arrangement.

Also, the correction can be applied limitedly to the cells that have a high frequency of use. Thus, the correction may be applied with regard to the correcting precision while suppressing a processing time.

### Embodiment 3

Next, an embodiment 3 of the present invention will be explained hereunder.

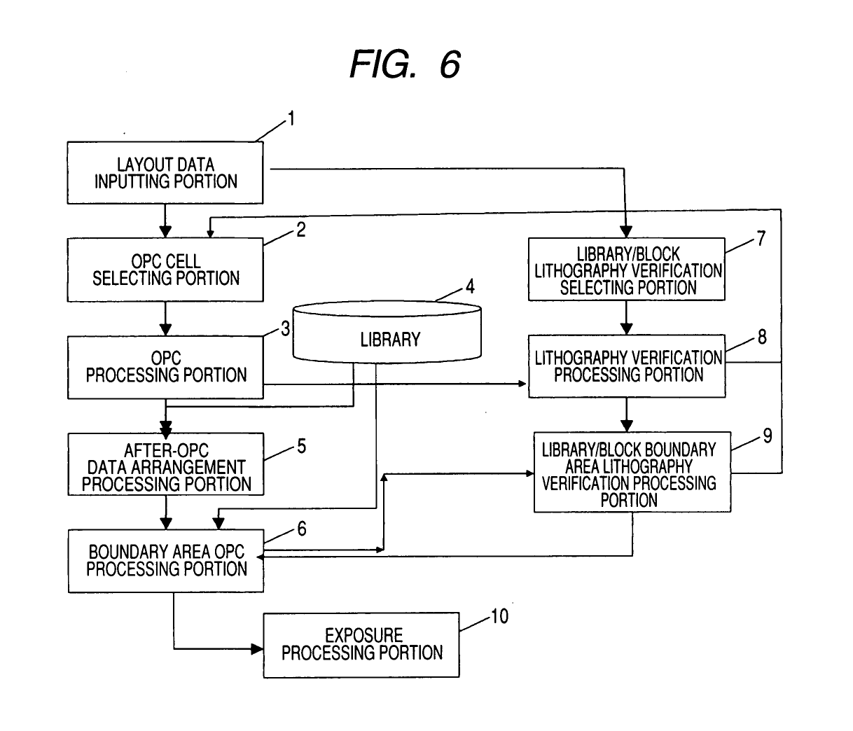

As shown in FIG. 6, this semiconductor device manufacturing system has further a verifying function portion in addition to the system explained in the embodiment 1 and shown in FIG. 2. This verifying function portion has a library/block lithography verification selecting portion 7 for selecting the to-be-verified cells (blocks) from the layout data being input from the layout data inputting portion 1, a lithography verification processing portion 8 for applying a lithography verification to the cells selected by the verification. selecting portion 7, a boundary area lithography verification processing portion 9 for applying the lithography verification to the cell boundary areas.

The lithography verification processing portion 8 does the simulation of the cells selected by the verification selecting portion 7 by using the output data of the OPC processing portion 3, and then compares the simulation result with the corresponding layout data to verify whether or not a difference between them is less than a predetermined value. Also, the boundary area lithography verification processing portion 9 does the simulation of the cells selected by the verification selecting portion 7 by using the output data of the boundary area OPC processing portion 6, and then compares the simulation result with the corresponding layout data to verify whether or not a difference between them is less than a predetermined value. If the difference between them is less than a predetermined value, the boundary area lithography verification processing portion 9 outputs the EB data being output from the boundary area OPC processing portion 6 to the exposure processing portion 10. In contrast, if a difference calculated by the boundary area lithography verification processing portion 9 exceeds a predetermined value, the process goes back to the OPC cell selecting portion 2 again and then the selection of the cells to which the OPC process should be applied is executed based on detailed conditions. Also, if a difference calculated by the lithography verification processing portion 8 exceeds a predetermined value, the process goes back to the OPC cell selecting portion 2 again and then the selection of the cells to which the OPC process should be applied is executed based on detailed conditions. Since respective processing portions are similar to the embodiment 1, their explanation will be omitted herein.

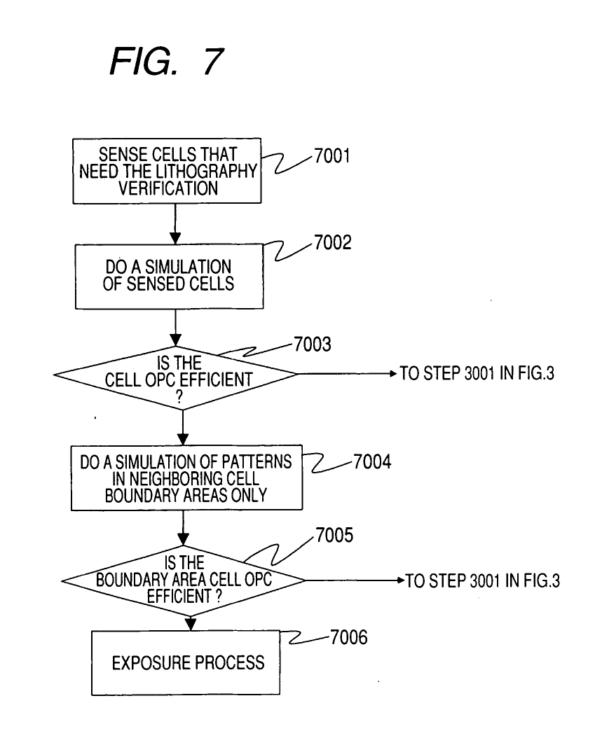

FIG. 7 shows a flow of the lithography verification of the semiconductor device manufactured by using the semiconductor device manufacturing system in FIG. 6.

First, the verification selecting portion 7 senses the cells that need the lithography verification from the layout data and selects them at the layer level (step 7001). Then, the lithography verification processing portion 8 runs the simulation of the selected cells by using the OPC-processed data of the concerned cells obtained by the OPC processing portion 3 in the embodiment 1 (step 7002). Then, the lithography verification processing portion 8 compares the simulation result with the layout data obtained from the data inputting portion, and then decides whether or not a difference between them is smaller than a previously decided predetermined value (step 7003).

In this decision step 7003, if it is decided that a difference between them is smaller than the previously decided predetermined value, the boundary area lithography verification processing portion 9 further executes the boundary area verifying process.

The boundary area lithography verification processing portion 9 does the simulation of the patterns in neighboring cell boundary areas only (step 7004). Here, the boundary area lithography verification processing portion 9 does the simulation by using the OPC-processed data of the concerned boundary areas obtained by the boundary area OPC processing portion 6 in the embodiment 1. Then, the boundary area lithography verification processing portion 9 compares the simulation result with the layout data obtained from the data inputting portion, and then decides whether or not a difference between them is less than a previously decided predetermined value (step 7005).

In this decision step 7005, if it is decided that a difference between them is less than the previously decided predetermined value, the boundary area lithography verification processing portion 9 outputs the EB data being output from the boundary area OPC processing portion 6 to the exposure processing portion 10 to execute the exposure process (step 7006).

In contrast, in this decision step 7005, if it is decided that a difference between them exceeds the previously decided predetermined value, the process goes back to step 3001 in the embodiment 1. Then, the selection of the cells is executed again and the OPC process is executed again.

In this manner, the verification is applied to a cell basis in the lithography verification processing portion 8, and the verification is applied only to the patterns in the neighboring cell boundary areas in the boundary area lithography verification processing portion 9.

In this manner, the cells that need the lithography verification are selected at an appropriate layer level, and then the verifying process is applied individually to the cells. Therefore, a time and a labor required to verify the same cell repeatedly can be omitted and also a CAD processing time can be reduced.

According to this method, the cell boundary portions that could not be verified in simulation step 7002 can be verified in detail in boundary portion simulation step 7004. Therefore, the lithography verification of the chip in which the after-OPC cells are arranged can be executed with high precision.

In this manner, a verifying time can be accelerated by applying the OPC verification on a cell basis. Also, the verifying precision of the cell boundaries can be improved by applying the OPC only to the cell boundaries again after the verification.

### Embodiment 4

Next, the library used in the semiconductor device manufacturing method will be explained hereunder. This library is formed by executing the correction and verification process previously in response to the photomask forming conditions, like an example is shown in FIG. 4(d), and stored in a database as a recording medium. Since the data obtained by applying the OPC process to the layout data of respective cells are stored in the library and also the boundary area OPC process data corresponding the number of neighboring cell combinations are stored, the layout design can be completed in a very short TAT.

Also, the layout data that permit the formation of the high-precision patterns effectively in a short time can be obtained by preparing correction data responding to various conditions such as lithography conditions applied when the resist patterns are formed by using the photomask, etching conditions such as etchant, temperature condition, etc. in the etching step, doping conditions applied in the doping step, annealing conditions, and the like as the library, in addition to the OPC-processed data corresponding to the photomask forming conditions as the library, and the combining these data.

The semiconductor device manufacturing method, the library used for the same, the recording medium, and the semiconductor device manufacturing system of the present invention are capable of realizing the high-precision machining of patterns while achieving improvements in productivity. Therefore, the present invention is useful for not only formation of patterns in the LSI but also formation of circuit patterns in the liquid crystal television, or the plasma display panel (PDP) and use in the fine pattern machining such as the micromachining, and the like.

What is claimed is:

1. A semiconductor device manufacturing method, comprising:
a step of dividing layout data of an integrated circuit constituting a semiconductor device into a plurality of blocks;
an OPC processing step of applying an optical proximity correction (referred to as OPC hereinafter) every block;
a boundary portion correcting step of correcting patterns of boundary portions between the blocks; and
a step of forming desired patterns by executing a lithography simulation based on the layout data after the boundary portion correcting step.

2. The semiconductor device manufacturing method, according to claim 1, further comprising:
a step of dividing the layout data into a plurality of cells;
an OPC processing step of applying an optical proximity correction (abbreviated as OPC hereinafter) every cell; and
a boundary portion correcting step of correcting patterns of the boundary portions between the cells.

3. The semiconductor device manufacturing method, according to claim 2, further comprising:
a step of arranging/synthesizing respective OPC-applied cells, to which the OPC process is applied, to generate corrected layout data.

4. The semiconductor device manufacturing method, according to claim 3, wherein the boundary portion correcting step is a step of correction patterns of the cell boundary portions to shrink.

5. The semiconductor device manufacturing method, according to claim 1, wherein the boundary portion correcting step is a step of correcting patterns of divided blocks or the cell boundary portions in compliance with a correction rule decided previously based on a design rule.

6. The semiconductor device manufacturing method, according to claim 3, wherein the boundary portion correcting step is a step of correcting patterns of divided blocks or the cell boundary portions in compliance with a correction rule decided previously in response to a model.

7. The semiconductor device manufacturing method, according to claim 5, wherein the boundary portion correcting step adjusts partially the correction rule in response to a required pattern precision.

8. The semiconductor device manufacturing method, according to claim 5 or 6, wherein the boundary portion correcting step sets the correction rule uniformly over a whole chip.

9. The semiconductor device manufacturing method, according to claim 3, wherein the OPC processing step applies the OPC process only to cells that are used in the integrated circuit in excess of a predetermined number.

10. The semiconductor device manufacturing method, according to claim 3, further comprising:
a storing step of storing OPC-applied cells obtained by applying the correction to the boundary portions of particular cells obtained in the OPC processing step as a library when particular cells are located adjacently; and
a step of taking out the OPC-applied cells from the library and applying.

11. The semiconductor device manufacturing method, according to claim 1 or 2, further comprising:
a step of applying a lithography simulation verification (referred to as a “lithography verification” hereinafter) on a divided-unit basis.

12. The semiconductor device manufacturing method, according to claim 2, further comprising:
a step of applying the lithography verification only to the cell boundary portions in the integrated circuit.

13. A computer-readable recording medium in which procedures in respective steps in the semiconductor device manufacturing method set forth in claim 1 are recorded.

14. A library for storing data to which an OPC process is applied in the semiconductor device manufacturing method set forth in claim 1.

15. A semiconductor device manufacturing system, comprising:
a data inputer, inputting layout data of an integrated circuit constituting a semiconductor device;
a divider, dividing the layout data input by the data imputer into a plurality of blocks;
an OPC processor, applying an optical proximity correction (referred to as OPC hereinafter) every block;
a synthesizer, arranging/synthesizing respective OPC-applied blocks to which the OPC process is applied; and
an exposure executor, executing an exposure based on corrected layout data to form desired patterns on a mask blank;
wherein the OPC processor has a library that stores OPC-processed data of respective blocks and boundary portion correction data used to correct patterns of boundary portions between the blocks, and
the synthesizer reads the data from the library and synthesizes the data to generate the layout data.
